(19) United States
(12) Patent Application Publication
(10) Pub. No.: US 2025/0201211 A1
(43) Pub. Date: Jun. 19, 2025

(54) USER SELECTED DISPLAY PANEL ADJUSTMENT

(71) Applicant: Hewlett-Packard Development Company, L.P., Spring, TX (US)

(72) Inventors: Alexander Williams, Spring, TX (US); Anthony Kaplanis, Spring, TX (US); Timothy Guynes, Spring, TX (US)

(73) Assignee: Hewlett-Packard Development Company, L.P., Spring, TX (US)

(21) Appl. No.: 18/845,734

(22) PCT Filed: Mar. 21, 2022
(86) PCT No.: PCT/US2022/021124

§ 371 Date: Sep. 10, 2024

(51) Int. Cl. G09G 5/377; H04N 21/426; H04N 21/431; H04N 21/4728; H04N 21/485

(52) U.S. Cl. CPC G09G 5/377; H04N 21/42653; H04N 21/4312; H04N 21/4728; H04N 21/4854; G09G 2320/0666; G09G 2320/0673; G09G 2354/00

(57) ABSTRACT

In an example implementation according to aspects of the present disclosure, a display monitor comprising a display panel, an embedded processor and a non-volatile memory. The non-volatile memory hosts instructions for the embedded processor to receive an enable signal corresponding to an onscreen display input and adjust an area of the display panel corresponding to a user selection.

### BACKGROUND

Display systems present video renderings with rapidly changing content. The rapidly changing content often presents images that may direct the focus of a viewer.

### BRIEF DESCRIPTION OF THE DRAWINGS

FIG. 1 illustrates a display monitor for user selected display panel adjustment, according to an example;

FIG. 2 illustrates a display monitor for touch-enabled user selected display panel adjustment, according to an example;

FIG. 3 is illustration of an on-screen display enabled of a user selected display panel according to another example of the present disclosure; and

FIG. 4 is a computing device for supporting computer readable media of a user selected display panel adjustment, according to an example.

### DETAILED DESCRIPTION

Display monitors are used to view a video stream from a host device. A host device may be a computer used for entertainment. In some instances, the video stream may be intentionally rendered with oversaturated black image composition, so a subject within the image may not be readily visible on the display monitor.

As disclosed herein, a display monitor to incorporate an embedded processor, a display panel, and a non-volatile memory to host instructions to receive an enable signal corresponding to an onscreen display input and adjust an area of the display panel corresponding to a user selection. The display monitor may use the received enable signal to toggle a “flashlight” effect applied to the video stream as presented by the display panel.

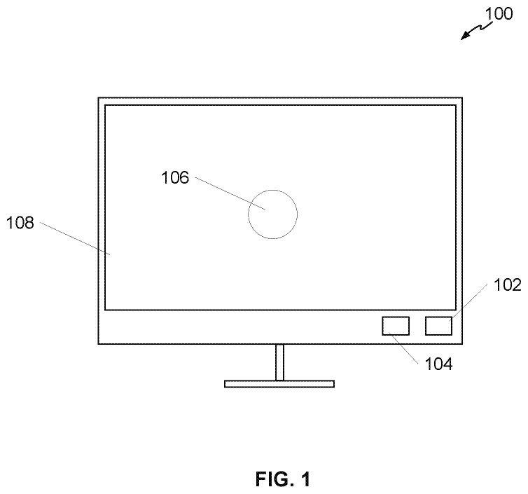

FIG. 1 illustrates a display monitor for user selected display panel adjustment, according to an example. The display monitor 100 may include an embedded processor 102, a non-volatile memory 104, and area of interest 106 inclusive to the display panel 108. The display monitor 100 may be presented as a stand-alone computer monitor. The display monitor 100 may support a number of different input ports corresponding to a number of different video transport specifications. For example, the display monitor 100 may include high-definition multimedia interface (HDMI) ports, DisplayPort (DP) ports, Universal Serial Bus Type C (USB-C) ports that support Alt mode for non-USB transmission, Digital Video Interface (DVI), and others. The display monitor 100, in one implementation, may be a gaming monitor.

The display monitor 100 may include an embedded processor 102. The embedded processor 102 may receive signals from any of the number of different input ports. The embedded processor 102 may decode the signals and operate the display panel 108. The embedded processor 102 may be communicatively coupled to the display panel 108. The embedded processor 102 may be designed to work with different types of display panels 108. For example, the embedded processor 102 may control the liquid crystal display (LCD) pixels as well as the backlight (or backlight array) for the panel. The embedded processor 102 may decode a video signal received from the input port, and then drive the LCD panel and backlight to render the video stream encoded in the video signal, on the display monitor 100.

The embedded processor 102 may manipulate LCD panel after the decode is complete to provide the appearance additional visual elements to the video stream visualized on the display monitor 100. For example, the embedded processor 102 may control the display panel 108 to render an on-screen display element overlaid on the decoded video signal. Additionally, the embedded processor 102 may manipulate color attributes (hue, saturation, luminance, red, blue, green, etc.) decoded from the video stream. In light emitting diode (LED) backlight implementations of the display panel 108, the embedded processor 102 may control the power delivered to each LED in an LED array of the backlight.

A non-volatile memory 104 may be communicatively coupled to the embedded processor 102. The non-volatile memory 104 may host instructions readable and interpretable by the embedded processor 102. The embedded processor 102 may retrieve instructions from the non-volatile memory 104. Instructions hosted in the non-volatile memory 104 may include instructions on how the embedded processor 102 interacts with the display panel 108. The instructions may define the operating properties of the embedded processor 102 to enable a signal corresponding to an onscreen display input. Additionally, the instructions may cause the embedded processor 102 to adjust and area of the display panel 106 corresponding to a user selection. In some implementations the area of the display panel 106 may correspond to an area of interest and may be utilized interchangeably throughout this description. The instructions may also provide logic to understand and respond to user input such as the receipt and action corresponding to a button push. In some implementations the instructions hosted in non-volatile memory 104 may provide logic to accept input from a touch-based input system 210.

In one implementation, the non-volatile memory 104 may host instructions to increase a backlight value of the display panel of the area. In this implementation, the embedded processor 102 may activate or provide more power to a backlight corresponding to the area or area of interest. The power provided to the backlight may correspond to the backlight value as a proportional increase over the power that may be currently supplied to the backlight. In a display panel 108 implemented with LED arrays, the backlight value of the area may be interpolated by the embedded processor 102 so that a gradient may be formed from the edge of the area to the center of the area.

In another implementation, the non-volatile memory 104 may host instructions to adjust the area of the display panel 108 by applying a color histogram analysis of the area. The color histogram may provide a color mapping corresponding to the color space of the display panel 108 to which attributes of color may be augmented to provide more visual contrast. For example, in an red, green, blue (RGB) color space, red, green and blue values within the area of the display panel 108 may be increase or decreased based on the histogram. In this implementation, colors in the affected area of the display panel 108, may be augmented to bring to values lifted away from black. The lifting of the colors away from black, provides a lightening effect, similar to a flashlight illuminating an object in the video stream.

In another implementation, the non-volatile memory 104 may host instructions to adjust the area of the display panel 108 by adjusting the RGB values of a RGB backlighting solution incorporated into the display panel 108. The embedded controller 102 may adjust the RGB black values of a RGB backlighting solution. RGB gamma curve values may be applied by the embedded controller to lift the rendered colors to more human-perceivable color values. Additionally, more than one technique may be applied to adjust the colors of the area of interest simultaneously.

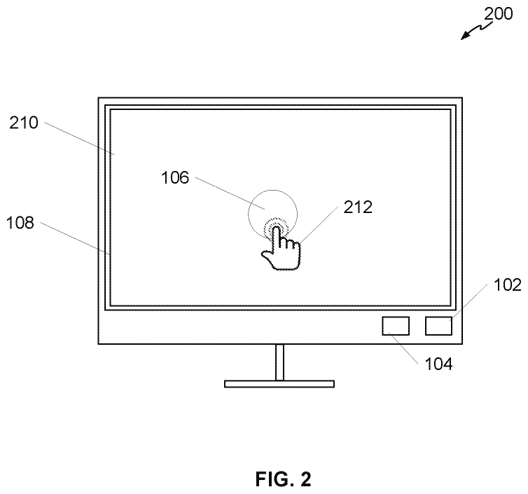

FIG. 2 illustrates a display monitor 200 for touch-enabled user selected display panel adjustment, according to an example. The display monitor 200 in FIG. 2 is similar to that of the display monitor 100 illustrated in FIG. 1. The display monitor 200 may include a touch-based input system 210 to receive touch-based input 212. The touch-based input system 210 may receive a physical interaction input, akin to a finger touch, to select a portion of the display monitor corresponding to an area of the display. In FIG. 2 the touch-based input system 210 is illustrated traversing a substantial portion of the display panel 108 for clarity of viewing. In most implementations, the touch-based input system 210 may coincide with the total surface of the display panel 108 providing touch-based input 212 over the entirety of the display panel 108. The touch-based input system 210 may be implemented as a touch screen utilizing capacitive, resistive, or other touch-based technology.

Similar to the display monitor 100 of FIG. 1, the display monitor 200 may included an embedded processor 102 and non-volatile memory 104. The non-volatile memory 104 may host instructions that when executed cause the embedded processor 102 to receive a user selection from the touch-based input system 210, corresponding to an area of interest 106 of the display panel 108. The user selection may correspond to an area of the display panel 108 that the user is interested in lightening a corresponding video stream. Simply stated, the user may tap the touch-based input system 210 to select the area of interest of the display panel 108.

User input gestures may also be supported to select an area of interest. For example, a user may tap and drag their finger across the touch-based input system 210 to create a circle centered at the tap, and the radius of the circle corresponding to the distance from the tap through the drag. Likewise, for other geometric shapes, a similar approach may be created. For a square or rectangular area of interest, the tap may correspond to a corner, and the drag may correspond to the diagonal of the square or rectangle.

The instructions hosted in the non-volatile memory 104 may cause the embedded processor 102 to store the area of interest in the non-volatile memory. Once the user makes a selection, the area of interest 106 may be stored. The area of interest 16 may be stored as an array of pixels corresponding to the display. In another implementation, the area of interest 16 may be stored in terms of geometric shapes interpretable by the embedded processor 102. In one implementation, an indicator may be stored to note what geometric shape, and the data type corresponding to location and size may be dynamic based on the indicator. For example, an indicator corresponding to “circle” may be stored within the non-volatile memory 104. The corresponding data type may comprise an origin (e.g., the center of the circle within the display panel) and a radius, where the origin is cartesian value, and the radius is a distance measured in pixels.

The instructions hosted in the non-volatile memory 104 may cause the embedded processor 102 to receive an enable signal corresponding to an onscreen display input. An enable signal may correspond to a toggle on the display panel's on-screen display (not pictured). The enable signal indicates to the embedded processor 104 that the user is enabling an adjustment to the area of interest 106.

The instructions hosted in the non-volatile memory 104 may cause the embedded processor 102 to retrieve the area of interest from the non-volatile memory. As described previously in relation to storing in the non-volatile memory 104, an indicator may be utilized to determine how to interpret the data type stored with the indicator.

The instructions hosted in the non-volatile memory 104 may cause the embedded processor 102 to adjust an area of the display panel corresponding to the area of interest 106. The embedded processor 102 may utilized the retrieved parameters of the area of interest (e.g., shape, size, and location) and apply adjustment to only that section of the display panel 108. In some implementations, a color histogram may be utilize to augment the color values of the area of interest 106. In other implementations, the embedded processor 102 may apply more power to the backlight of the display panel 108 in the area of interest 106. The embedded processor 102 may have logic internal or as instructions to map backlight control to sections of the screen or portions of an LED backlight array.

In some implementations, a video stream specific implementation may be utilized to determine the area of interest. Some video communication methods allow for metadata to be encoded within the communication protocol before being transmitted to the display monitor 210. In these implementations, the video stream may have an area of interest 106 encoded within the video stream. A display monitor 200 with an embedded processor 102 capable of receiving and decoding this metadata may translate this area of interest 106 within the metadata and store it to the non-volatile memory 104. In some implementations, the metadata received area of interest 106 may override a user selected area of interest 106. In this example, a developer could encode a video game to provide metadata within the game as high dynamic range (HDR) content. If the display monitor 200 can support HDR content, as determined by the embedded processor 102, the embedded processor 102 may utilize the area of interest 106 suggested by the developer of the video game. So for these implementations the instructions hosted in the non-volatile memory 104 may cause the embedded processor 102 to evaluate a video stream for HDR metadata, where the HDR metadata may include the area of interest 106.

The instructions hosted in the non-volatile memory 104 may cause the embedded processor 102 to adjust color values corresponding to the video stream in the area of interest 106 based on the metadata. The metadata may include information pertinent to color adjustment. For example, a color histogram may be encoded in the metadata for a specific scene in the video game by the developer. Updates to the metadata based on scene changes may also update the area of interest 106 as well as a corresponding color histogram based on the current (or upcoming) scenes.

The instructions hosted in the non-volatile memory 104 may cause the embedded processor 102 to receive a signal in the metadata. The signal may correspond to a disablement feature. The signal may indicate to the embedded processor 102 that any adjustments may be reverted to unchanged form.

The instructions hosted in the non-volatile memory 104 may cause the embedded processor 102 to then revert an adjustment of the area of the display panel to correspond with the video stream. Effectively, reverting the adjustment, toggles any color adjustment or backlight adjustment to an off state. In this example, the encoded signal allows the developer of a video game to programmatically toggle the “flashlight” feature of the display monitor 200 to disable the feature and level the playing field for remote gamers not utilizing a display monitor 200 utilizing an embedded processor 102 capable of receiving the metadata.

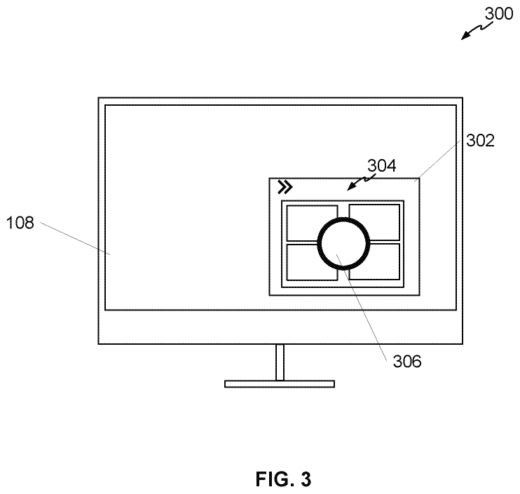

FIG. 3 is illustration of an on-screen display enabled of a user selected display panel according to another example of the present disclosure. FIG. 3 is similar to FIG. 1 in internal components (e.g., embedded processor 102, and non-volatile memory 104). The internal components are not shown in reference to FIG. 3, but will be referenced by their counterparts in FIG. 1.

In this implementation the display monitor 300 does not have a touch-based input system. The display monitor 300 may include an on-screen display (OSD) 302. The OSD may be stored in the non-volatile memory 104 and executed by the embedded processor 102 to cause the display panel 108 to provide a user a predetermined plurality of areas 304 in the OSD 302 corresponding to areas of the display panel 108. In this illustration, the plurality of areas 304 correspond to the quadrants of the display panel 108, as well as a center circle 306. In this example, the center circle, may correspond to an area within the display panel 108 where commonly a targeting reticule may be rendered in a video stream.

Similar to the touch-based input of FIG. 2, the instructions hosted in the non-volatile memory 104 may cause the embedded processor 102 receive the user selection of the predetermined plurality of areas. The selection may correspond to an area of interest for the user. In this example, the area of interest may not be user defined, but instead, user selected.

Again, similar to the implementation described in reference to FIG. 2, the instructions hosted in the non-volatile memory 104 may cause the embedded processor 102 store the user selection.

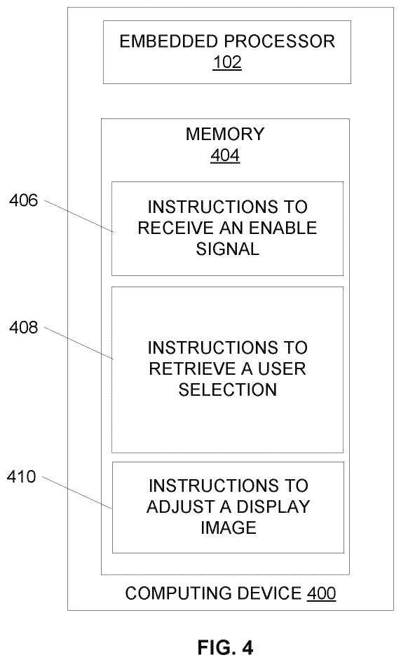

FIG. 4 is a computing device for supporting customizable onscreen display reference points, according to an example. The computing device 400 depicts an embedded processor 102 and a memory device 404 and, as an example of the computing device 400 performing its operations, the memory device 404 may include instructions 406-410 that are executable by the embedded processor 102. The embedded processor 102 may be synonymous with a controller commonly found within display systems. Embedded processor 102 may be a hardware scaler. The memory device 404 can be said to store program instructions that, when executed by embedded processor 102, implement the components of the computing device 400. The executable program instructions stored in the memory device 404 include, as an example, instructions to receive an enable signal corresponding to an onscreen display input 406, instructions to retrieve a user selection corresponding to an area of a display panel 408, and instruction to adjust a displayed image in the area of the display panel corresponding to the user selection 410.

Memory device 404 represents generally any number of memory components capable of storing instructions that can be executed by embedded processor 102. Memory device 404 is non-transitory in the sense that it does not encompass a transitory signal but instead is made up of at least one memory component configured to store the relevant instructions. As a result, the memory device 404 may be a non-transitory computer-readable storage medium. Memory device 404 may be implemented in a single device or distributed across devices. Further, the memory device 404 may be fully or partially integrated in the same device as embedded processor 102, or it may be separate but accessible to that device and embedded processor 102.

In one example, the program instructions 406-410 can be part of an installation package that, when installed, can be executed by embedded controller 102 to implement the components of the computing device 400. In this case, memory device 404 may be a portable medium such as a CD, DVD, or flash drive, or a memory maintained by a server from which the installation package can be downloaded and installed. In another example, the program instructions may be part of an application or applications already installed. Here, memory device 404 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A display monitor comprising:
a display panel;
an embedded processor communicatively coupled to the display panel; and
a non-volatile memory communicatively coupled to the embedded processor,
the memory storing instructions that when executed cause the embedded processor to:
receive an enable signal corresponding to an onscreen display input; and
adjust an area of the display panel corresponding to a user selection.

2. The display monitor of claim 1, the adjust instructions further comprising increase a backlight value of the display panel of the area.

3. The display monitor of claim 1, the adjust instruction further comprising apply a color histogram analysis of the area.

4. The display monitor of claim 1, the instructions further comprising:
provide a user a predetermined plurality of areas within the display panel;
receive the user selection of the predetermined plurality of areas; and
store the user selection.

5. The display monitor of claim 4, wherein one of the predetermined plurality of areas comprises an area of the display panel corresponding to a targeting reticule rendered in a video stream.

6. A display monitor comprising:
a display panel;
a touch-based input system corresponding to a complete surface area of the display panel;
an embedded controller communicatively coupled to the display panel and the touch-based input system; and
a memory storing instructions that when executed cause the embedded process to:
receive a user selection from the touch-based input system,
corresponding to an area of interest of the display panel;
store the area of interest in a non-volatile memory;
receive an enable signal corresponding to an onscreen display input;
retrieve the area of interest from the non-volatile memory; and
adjust an area of the display panel corresponding to the area of interest.

7. The display monitor of claim 6, the adjust instructions further comprising increase a backlight value of the display panel of the area.

8. The display monitor of claim 6, the adjust instruction further comprising apply a color histogram analysis of the area.

9. The display monitor of claim 6, the instructions further comprising:
evaluate a video stream for high dynamic range metadata; and
adjust color values corresponding to the video stream in the area of interest based on the metadata.

10. The display monitor of claim 9 the instructions further comprising:
receive a signal in the metadata; and
revert an adjustment of the area of the display panel to correspond with the video stream.

11. A non-transient computer readable storage medium comprising instructions that when executed cause an embedded controller to:
receive an enable signal corresponding to an onscreen display input;
retrieve a user selection corresponding to an area of a display panel; and
adjust a displayed image in the area of the display panel corresponding to the user selection.

12. The computer readable storage medium of claim 11, the instructions further comprising:
evaluate a video stream for high dynamic range metadata; and
adjust color values corresponding to the displayed image based on the metadata.

13. The computer readable storage medium of claim 11, wherein one of the predetermined plurality of areas comprises an area of the display panel corresponding to a targeting reticule rendered in a video stream.

14. The computer readable storage medium of claim 11, wherein the video stream corresponds to a rendering of a sequenced plurality of frames rendered of a video game.

15. The computer readable storage medium of claim 11, the adjust instruction comprising manipulation a gamma curve corresponding to the displayed image.
